(19) United States
(12) Patent Application Publication
(10) Pub. No.: US 2015/0331885 A1
(43) Pub. Date: Nov. 19, 2015

(54) ROLE TRANSFER BETWEEN USERS OF A COMPUTER SYSTEM

(71) Applicant: International Business Machines Corporation, Armonk, NY (US)

(72) Inventors: Paul R. Bastide, Boxford, MA (US); Daniel B. Harris, Andover, MA (US); Fang Lu, Billerica, MA (US)

(73) Assignee: International Business Machines Corporation, Armonk, NY (US)

(21) Appl. No.: 14/279,708

(22) Filed: May 16, 2014

(51) Int. Cl. G06F 17/30

(52) U.S. Cl. CPC G06F 17/30165

(57) ABSTRACT

A plurality of collaboration artifacts associated with a first user are identified in a computer system. One or more features are identified from each of the plurality of collaboration artifacts. At least some of the plurality of collaboration artifacts are clustered based on similarity of the one or more features, resulting in a plurality of clusters. The first user is prompted to make a selection from the plurality of clusters and the selection of the first user is received. The collaboration artifacts in the selection are transferred to a second user.

### BACKGROUND

The present disclosure relates to transferring data between users of a computer system, and more specifically, to transferring collaboration artifacts associated with particular roles between users of a computer system.

In an organization, people may have several roles for which they have responsibilities. For example, they may be a part of several teams and may have different positions on each team, such as member or leader. The person may have emails, calendar entries, and other collaboration artifacts related to these specific roles.

### SUMMARY

According to embodiments of the present disclosure, a method for transferring roles is disclosed. The method includes identifying a plurality of collaboration artifacts in a computer system. The plurality of collaboration artifacts are associated with a first user. The method further includes identifying one or more features from each of the plurality of collaboration artifacts. The method further includes clustering at least some of the plurality of collaboration artifacts based on similarity of the one or more features, resulting in a plurality of clusters. The method further includes prompting the first user to make a selection from the plurality of clusters and receiving the selection of the first user. The method further includes transferring collaboration artifacts in the selection to a second user.

Further disclosed herein are embodiments of a computer program product for transferring roles. The computer program product includes a computer readable storage medium having program code embodied therewith. The program code is executable by a computer to perform a method. The method includes identifying a plurality of collaboration artifacts in a computer system. The plurality of collaboration artifacts are associated with a first user. The method further includes identifying one or more features from each of the plurality of collaboration artifacts. The method further includes clustering at least some of the plurality of collaboration artifacts based on similarity of the one or more features, resulting in a plurality of clusters. The method further includes prompting the first user to make a selection from the plurality of clusters and receiving the selection of the first user. The method further includes transferring collaboration artifacts in the selection to a second user.

Further disclosed herein are embodiments of a computer system for transferring roles. The computer system includes one or more processors, one or more computer-readable memories, one or more computer-readable tangible storage devices, and program instructions stored on at least one of the one or more storage devices for execution by at least one of the one or more processors via at least one of the one or more memories. The program instructions for execution include program instructions to identify a plurality of collaboration artifacts in a computer system. The plurality of collaboration artifacts are associated with a first user. The program instructions for execution further include program instructions to identify one or more features from each of the plurality of collaboration artifacts. The program instructions for execution further include program instructions to cluster at least some of the plurality of collaboration artifacts based on similarity of the one or more features, resulting in a plurality of clusters. The program instructions for execution further include program instructions to prompt the first user to make a selection from the plurality of clusters and program instructions to receive the selection of the first user. The program instructions for execution further include program instructions to transfer collaboration artifacts in the selection to a second user.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts an example method for transferring roles between a first user and a second user of a computer system.

FIG. 2 depicts a block diagram of an example computer system for transferring roles between a first user and a second user of a computer system.

FIG. 3 depicts an example visual representation of the clusters of collaboration artifacts.

FIG. 4 depicts a high-level block diagram of an example system for implementing one or more embodiments of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to transferring roles between users of a computer system, more particular aspects relate to transferring collaboration artifacts from a first user to a second user. While the present disclosure is not necessarily limited to such applications, various aspects of the disclosure may be appreciated through a discussion of various examples using this context.

When a person changes positions within an organization, the roles and responsibilities that the person had may be transferred to others within the organization. All roles may be transferred to a single person or different roles may be transferred to different people. The role transfer may include transferring collaboration artifacts associated with a particular role from the first user to the second user. Depending on the situation, large amounts of information may need to be collected and distributed within a short amount of time.

Embodiments of the present disclosure may provide for transferring one or more roles from a first user of a computer system to a second user. Collaboration artifacts may be identified which are associated with the first user. Features may be identified for each of the collaboration artifacts. The collaboration artifacts may be clustered based on the similarities between the identified features. The first user may select collaboration artifacts in the clusters to transfer to the second user.

Collaboration artifacts may be objects stored in the computer system which are associated with multiple users. Examples include emails, calendar entries, shared documents, forums, and wikis. These items may be useful to a person taking on the role of another person within an organization. For example, emails between members of a team may provide the person with information on what the team has been discussing, as well as who is on the team. Similarly, calendar entries for meetings of team members may be useful to the person so they do not miss the meetings and have information regarding the meetings. Shared documents, forums, and wikis associated with a team may allow the person access to information important for performing their role on the team and the role may include ownership of the documents, forums, and wikis.

Features identified from the collaboration artifacts may include, for example, keywords in the artifact, ownership of the artifact, users associated with the artifact, creation or modification date of the artifacts, and scheduling date of the artifact. These features may be identified using natural language processing to extract the features from unstructured and structured data associated with the collaboration artifacts. Natural language processing is well known in the art and there are many methods which could be used to extract the features from the collaboration artifacts.

For example, features from an email may include keywords used in the subject line and body of the email, the sender and recipients (users associated with the artifact), and the date of the email (creation date). For a calendar entry, features may include keywords from the subject line and description of the meeting, participants (users associated with the artifact), chair of the meeting (ownership), and date the meeting is scheduled. For a shared document, forum, or wiki, features may include keywords in the text, ownership of the artifact, and users with access to the artifact (users associated with the artifact).

A clustering algorithm or any method of categorization or grouping based on statistical similarity may be used to create clusters of collaboration artifacts. There are many clustering algorithms known in the art which may be used to create clusters of collaboration artifacts based on the similarity of their features. Clustering the collaboration artifacts may create a cluster for each role of the first user. A collaboration artifact associated with a particular role may be more likely to have similar features to other collaboration artifacts associated with the particular role than collaboration artifacts associated with other roles. For example, collaboration artifacts relating to a person's role with Team A, which has members B, C, and D, and is working on Project E may have similar features such as keywords which are associated with Project E and associated users which include members B, C, and D.

Transferring the collaboration artifact to the second user may include transferring ownership of the collaboration artifact, providing a copy of the collaboration artifact, providing access to the collaboration artifact, or other activities that effect the transfer. For example, if the collaboration artifact is a forum which the first user, as owner, has administrative control, transferring the forum to the second user may include transferring the ownership from the first user to the second user. In another example, if the collaboration artifact is an email, transferring the email to the second user may include providing the second user with a copy of the email. In another example, if the collaboration artifact is a shared document, transferring the shared document may include adjusting the access permissions to allow access to the second user.

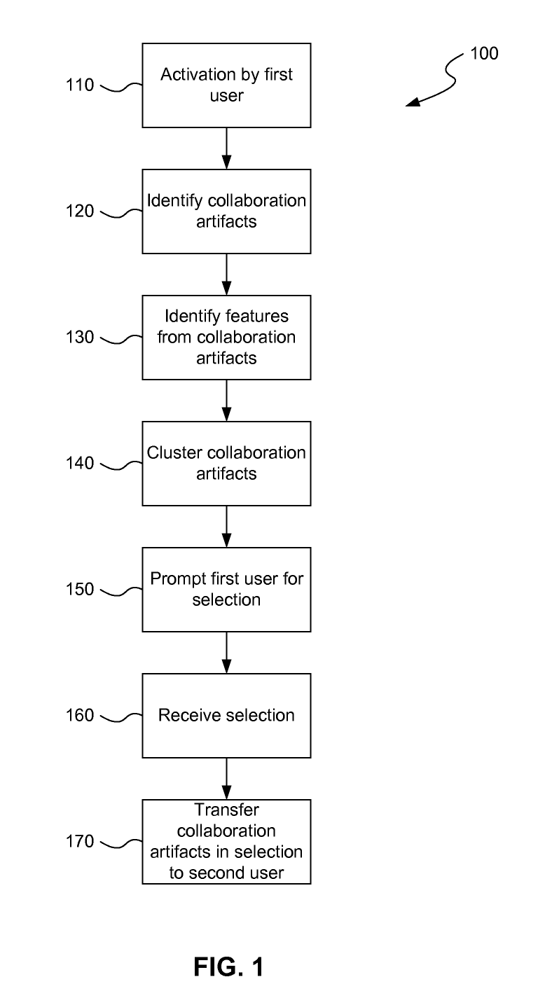

Referring to FIG. 1, a flow diagram of an example method 100 for transferring roles between a first user and a second user of a computer system is depicted. At block 110, a first user activates the role transfer process on the computer system.

At block 120, collaboration artifacts may be identified on the computer system. In some embodiments, this may involve identifying specific types of files, such as email files or calendar files. In some embodiments, this may involve identifying files in specified folders such as email folders or folders shared across a network.

At block 130, features may be identified from the collaboration artifacts. These features may include keywords, ownership, associated users, or any other features which could indicate association with a particular role. These features may be extracted from the collaboration artifacts using natural language processing on structured and unstructured data within the collaboration artifact.

At block 140, the collaboration artifacts may be clustered based on the similarity of their identified features. This may include some or all of the identified features. In some embodiments, some of the collaboration artifacts may be excluded from the clusters. For example, collaboration artifacts with creation, modification, or scheduling dates earlier than a specified date may be ignored for clustering. The resulting clusters may each contain collaboration artifacts associated with a particular role of the first user.

At block 150, the first user may be prompted to make a selection to transfer to a second user. The first user may be provided with a visual representation of the clusters which may include keywords and users associated with each cluster. The first user may make a selection by selecting one or more of the clusters in the visual representation. The user may make this selection using a mouse, touchscreen, keyboard, or any other computer input device. In some embodiments, the first user may be able to select specific artifacts within each cluster. At block 160, the selection is received from the first user.

At block 170, the collaboration artifacts in the selection may be transferred to the second user. Transferring the artifacts may include transferring ownership from the first user to the second user, providing a copy of the artifact to the second user, or providing access to the second user. The method of transferring an artifact may depend on the artifact and the system. Some artifacts may allow for ownership to be changed from one user to another while others may not allow ownership change. Providing a copy of an artifact may be accomplished using email or any other method. Providing access to the second user may include changing access control permissions or adding the second user to an access control list. The above examples of transferring artifacts are not meant to be exhaustive and other methods of transferring the artifacts could be used.

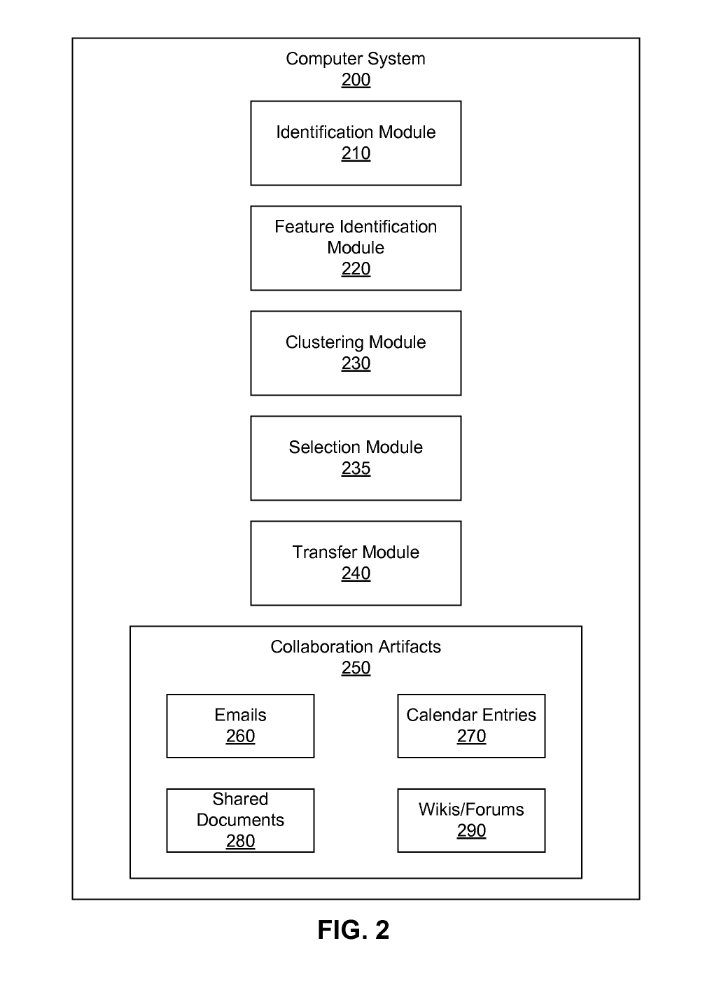

Referring to FIG. 2, a block diagram of an example computer system 200 for transferring roles between a first user and a second user of a computer system is depicted. Computer system 200 may be a single computing system or may be a system of interconnected computers. System 200 includes identification module 210, feature identification module 220, clustering module 230, selection module 235, and transfer module 240. Identification module 210 may be configured to identify collaboration artifacts 250 stored on computer system 200. Collaboration artifacts 250 may include emails 260, calendar entries 270, shared documents 280, wikis/forums 290, and other items not shown. Identification module 210 may be configured to identify collaboration artifacts 250 by locating specific file types or searching specific folders.

Feature identification module 220 may be configured to identify features of collaboration artifacts 250 associated with a first user. Feature identification module 220 may be configured to perform natural language processing to extract the features from collaboration artifacts 250.

Clustering module 230 may be configured to cluster collaboration artifacts 250 based on the similarity of the identified features. Clustering module 230 may be configured to apply a clustering algorithm to collaboration artifacts 250. Each cluster produced by clustering module 230 may represent a particular role of the user.

Selection module 235 may be configured to prompt the first user for a selection of collaboration artifacts to transfer to a second user. In some embodiments, selection module 235 may be configured to display a visual representation of the clusters and the first user may select parts of the visual representation using a computer input device to select clusters. In some embodiments, selecting a cluster on the visual representation may display specific collaboration artifacts within the cluster which may be individually selected by the first user. Selection module 235 may be further configured to receive the selection from the first user.

Transfer module 240 may be configured to transfer collaboration artifacts in the selection to the second user. Transfer module 240 may be configured to transfer the collaboration artifacts using different methods including transferring ownership to the second user, providing a copy to the second user, or providing access to the second user. The method may depend on the type of collaboration artifact.

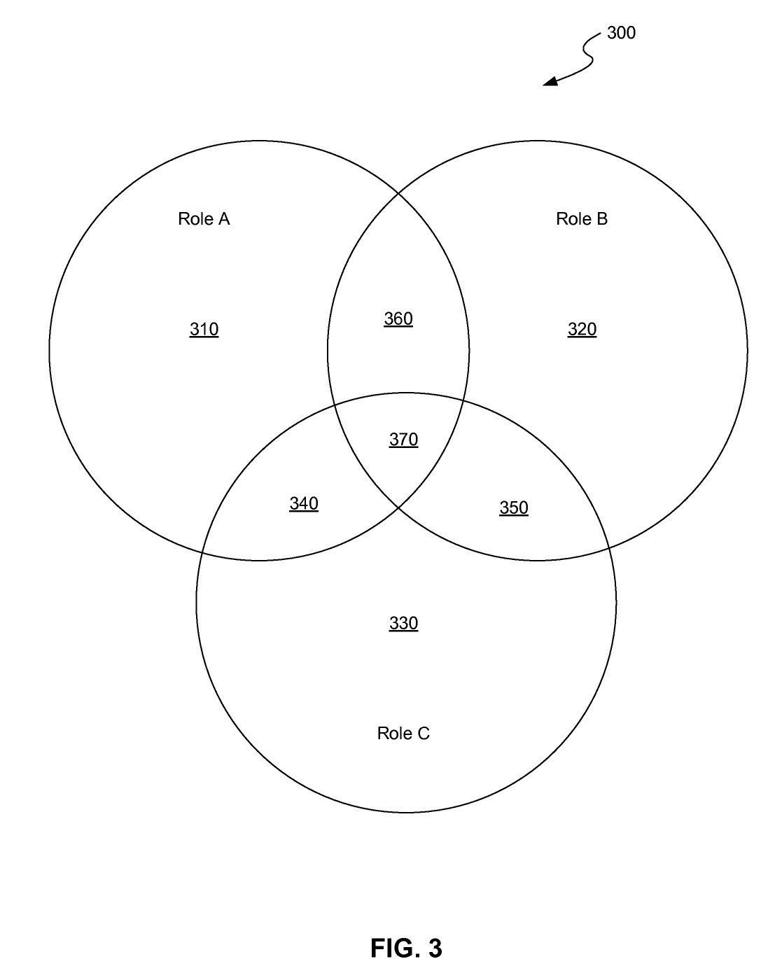

Referring to FIG. 3, an example visual representation 300 of the clusters of collaboration artifacts is depicted. As depicted, visual representation 300 is a Venn diagram, however, there are many possible visual displays which could be used as recognized by a person of ordinary skill in the art. Visual representation 300 displays three clusters which represent roles A, B, and C for a first user. Area 310 may represent collaboration artifacts with features which are similar and associated with role A. Area 320 may represent collaboration artifacts with features which are similar and associated with role B. Area 330 may represent collaboration artifacts with features which are similar and associated with role C. Areas 340, 350, and 360 may represent collaboration artifacts which may have features associated with two roles. These collaboration artifacts may be associated with either role or both roles. Area 370 may represent collaboration artifacts which have features associated with all three roles. These collaboration artifacts may be associated with any of the three roles.

A first user may be able to select any of areas 310-370 to transfer to a second user. For example, if the first user wants to transfer role A to a second user, the first user may select areas 310, 340, 360, and 370. However, the first user may select only area 310 if they want to transfer only the collaboration artifacts which are more likely to be associated with role A. In some embodiments, the first user may be able to select individual collaboration artifacts within an area. For example, if the first user wants to transfer role A to a second user, the first user may select area 310 and individual collaboration artifacts from areas 340, 360, and 370. The user may be provided with a list of collaboration artifacts represented by each area which the user may select. This may allow the first user to manually determine if the collaboration artifacts are associated with the role they want to transfer.

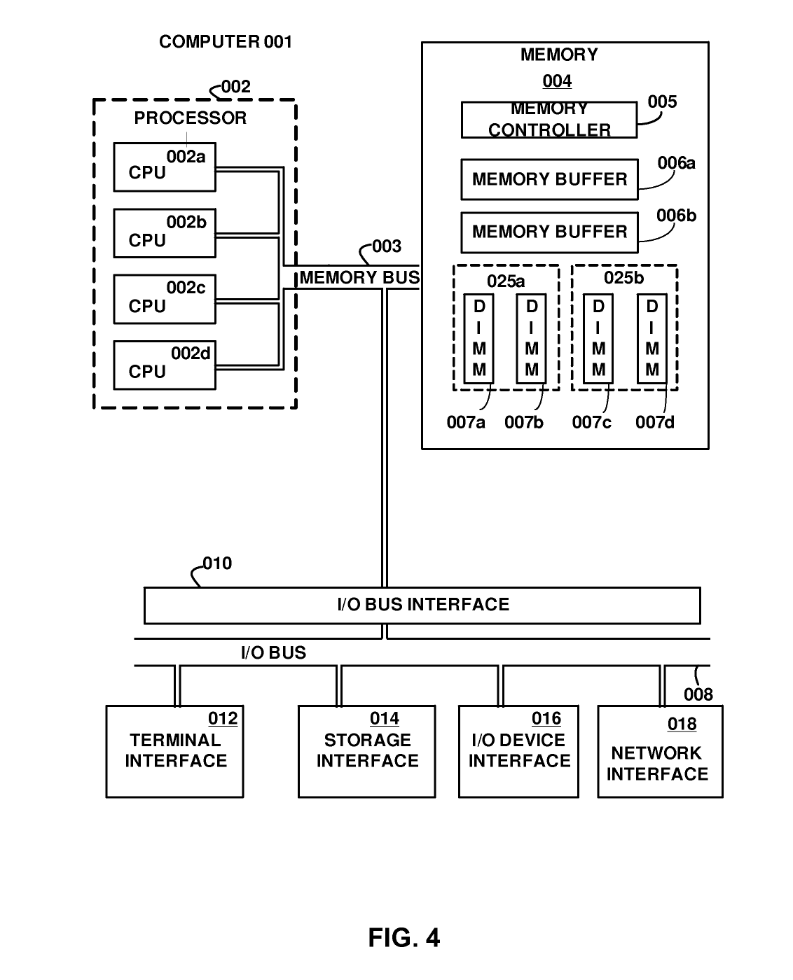

Referring to FIG. 4, a high-level block diagram of an example system for implementing one or more embodiments of the invention is depicted. The mechanisms and apparatus of embodiments of the present invention apply equally to any appropriate computing system. The major components of the computer system 001 comprise one or more CPUs 002, a memory subsystem 004, a terminal interface 012, a storage interface 014, an I/O (Input/Output) device interface 016, and a network interface 018, all of which are communicatively coupled, directly or indirectly, for inter-component communication via a memory bus 003, an I/O bus 008, and an I/O bus interface unit 010.

The computer system 001 may contain one or more general-purpose programmable central processing units (CPUs) 002A, 002B, 002C, and 002D, herein generically referred to as the CPU 002. In an embodiment, the computer system 001 may contain multiple processors typical of a relatively large system; however, in another embodiment the computer system 001 may alternatively be a single CPU system. Each CPU 002 executes instructions stored in the memory subsystem 004 and may comprise one or more levels of on-board cache.

In an embodiment, the memory subsystem 004 may comprise a random-access semiconductor memory, storage device, or storage medium (either volatile or non-volatile) for storing data and programs. In another embodiment, the memory subsystem 004 may represent the entire virtual memory of the computer system 001, and may also include the virtual memory of other computer systems coupled to the computer system 001 or connected via a network. The memory subsystem 004 may be conceptually a single monolithic entity, but in other embodiments the memory subsystem 004 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory or memory subsystem 004 may contain elements for control and flow of memory used by the CPU 002. This may include all or a portion of the following: a memory controller 005, one or more memory buffer 006 and one or more memory devices 007. In the illustrated embodiment, the memory devices 007 may be dual in-line memory modules (DIMMs), which are a series of dynamic random-access memory (DRAM) chips mounted on a printed circuit board and designed for use in personal computers, workstations, and servers. In various embodiments, these elements may be connected with buses for communication of data and instructions. In other embodiments, these elements may be combined into single chips that perform multiple duties or integrated into various types of memory modules. The illustrated elements are shown as being contained within the memory subsystem 004 in the computer system 001. In other embodiments the components may be arranged differently and have a variety of configurations. For example, the memory controller 005 may be on the CPU 002 side of the memory bus 003. In other embodiments, some or all of them may be on different computer systems and may be accessed remotely, e.g., via a network.

Although the memory bus 003 is shown in FIG. 4 as a single bus structure providing a direct communication path among the CPUs 002, the memory subsystem 004, and the I/O bus interface 010, the memory bus 003 may in fact comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 010 and the I/O bus 008 are shown as single respective units, the computer system 001 may, in fact, contain multiple I/O bus interface units 010, multiple I/O buses 008, or both. While multiple I/O interface units are shown, which separate the I/O bus 008 from various communications paths running to the various I/O devices, in other embodiments some or all of the I/O devices are connected directly to one or more system I/O buses.

In various embodiments, the computer system 001 is a multi-user mainframe computer system, a single-user system, or a server computer or similar device that has little or no direct user interface, but receives requests from other computer systems (clients). In other embodiments, the computer system 001 is implemented as a desktop computer, portable computer, laptop or notebook computer, tablet computer, pocket computer, telephone, smart phone, network switches or routers, or any other appropriate type of electronic device.

FIG. 4 is intended to depict the representative major components of an exemplary computer system 001. But individual components may have greater complexity than represented in FIG. 4, components other than or in addition to those shown in FIG. 4 may be present, and the number, type, and configuration of such components may vary. Several particular examples of such complexities or additional variations are disclosed herein. The particular examples disclosed are for example only and are not necessarily the only such variations.

The memory buffer 006, in this embodiment, may be intelligent memory buffer, each of which includes an exemplary type of logic module. Such logic modules may include hardware, firmware, or both for a variety of operations and tasks, examples of which include: data buffering, data splitting, and data routing. The logic module for memory buffer 006 may control the DIMMs 007, the data flow between the DIMM 007 and memory buffer 006, and data flow with outside elements, such as the memory controller 005. Outside elements, such as the memory controller 005 may have their own logic modules that the logic module of memory buffer 006 interacts with. The logic modules may be used for failure detection and correcting techniques for failures that may occur in the DIMMs 007. Examples of such techniques include: Error Correcting Code (ECC), Built-In-Self-Test (BIST), extended exercisers, and scrub functions. The firmware or hardware may add additional sections of data for failure determination as the data is passed through the system. Logic modules throughout the system, including but not limited to the memory buffer 006, memory controller 005, CPU 002, and even the DRAM may use these techniques in the same or different forms. These logic modules may communicate failures and changes to memory usage to a hypervisor or operating system. The hypervisor or the operating system may be a system that is used to map memory in the system 001 and tracks the location of data in memory systems used by the CPU 002. In embodiments that combine or rearrange elements, aspects of the firmware, hardware, or logic modules capabilities may be combined or redistributed. These variations would be apparent to one skilled in the art.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for transferring roles, the method comprising:
identifying a plurality of collaboration artifacts in a computer system, the plurality of collaboration artifacts associated with a first user;
identifying one or more features from each of the plurality of collaboration artifacts;
clustering at least some of the plurality of collaboration artifacts based on similarity of the one or more features, the clustering resulting in a plurality of clusters;
prompting the first user to make a selection from the plurality of clusters;
receiving the selection of the first user; and
transferring collaboration artifacts in the selection to a second user.

2. The method of claim 1, wherein a first feature from the one or more features is keywords.

3. The method of claim 1, wherein a first feature from the one or more features is associated users.

4. The method of claim 1, wherein one or more of the plurality of collaboration artifacts are selected from the group consisting of emails and calendar entries.

5. The method of claim 1, wherein a first feature from the one or more features is ownership, and wherein the transferring collaboration artifacts in the selection to the second user comprises:
transferring the ownership of one or more collaboration artifacts in the selection from the first user to the second user.

6. The method of claim 1, wherein a first feature from the one or more features is creation date, and wherein the at least some of the collaboration artifacts excludes collaboration artifacts with the creation date before a specified date.

7. The method of claim 1, further comprising:
displaying a visual representation of the plurality of clusters to the first user.

8. A computer program product for transferring roles, the computer program product comprising a computer readable storage medium having program code embodied therewith, the program code executable by a computer to perform a method comprising:
identifying a plurality of collaboration artifacts in a computer system, the plurality of collaboration artifacts associated with a first user;
identifying one or more features from each of the plurality of collaboration artifacts;
clustering at least some of the plurality of collaboration artifacts based on similarity of the one or more features, the clustering resulting in a plurality of clusters;
prompting the first user to make a selection from the plurality of clusters;
receiving the selection of the first user; and
transferring collaboration artifacts in the selection to a second user.

9. The computer program product of claim 8, wherein a first feature from the one or more features is keywords.

10. The computer program product of claim 8, wherein a first feature from the one or more features is associated users.

11. The computer program product of claim 8, wherein one or more of the plurality of collaboration artifacts are selected from the group consisting of emails and calendar entries.

12. The computer program product of claim 8, wherein a first feature from the one or more features is ownership, and wherein the transferring collaboration artifacts in the selection to the second user comprises:
transferring the ownership of one or more collaboration artifacts in the selection from the first user to the second user.

13. The computer program product of claim 8, wherein a first feature from the one or more features is creation date, and wherein the at least some of the collaboration artifacts excludes collaboration artifacts with the creation date before a specified date.

14. The computer program product of claim 8, wherein the method further comprises:
displaying a visual representation of the plurality of clusters to the first user.

15. A computer system for transferring roles, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to identify a plurality of collaboration artifacts in the computer system, the plurality of collaboration artifacts associated with a first user;
program instructions to identify one or more features from each of the plurality of collaboration artifacts;
program instructions to cluster at least some of the plurality of collaboration artifacts based on similarity of the one or more features, resulting in a plurality of clusters;
program instructions to prompt the first user to make a selection from the plurality of clusters;
program instructions to receive the selection of the first user; and
program instructions to transfer collaboration artifacts in the selection to a second user.

16. The computer system of claim 15, wherein a first feature from the one or more features is keywords and a second feature from the one or more features is associated users.

17. The computer system of claim 15, wherein one or more of the plurality of collaboration artifacts are selected from the group consisting of emails and calendar entries.

18. The computer system of claim 15, wherein a first feature from the one or more features is ownership, and wherein the program instructions to transfer collaboration artifacts in the selection to the second user comprises:
program instructions to transfer the ownership of one or more collaboration artifacts in the selection from the first user to the second user.

19. The computer system of claim 15, wherein a first feature from the one or more features is creation date, and wherein the at least some of the collaboration artifacts excludes collaboration artifacts with the creation date before a specified date.

20. The computer system of claim 15, wherein the program instructions for execution further comprise:
program instructions to display a visual representation of the plurality of clusters to the first user.
